(19) United States
(12) Patent Application Publication
(10) Pub. No.: US 2025/0290301 A1
(43) Pub. Date: Sep. 18, 2025

(54) HEIGHT ADJUSTABLE FAUCET AND ROTATABLY FLEXIBLE SPRAY HEAD

(71) Applicant: Kohler (China) Investment Co., Ltd., Shanghai (CN)

(72) Inventors: Mauricio CARVAJAL, Shanghai (CN); Dong YAN, Shanghai (CN)

(21) Appl. No.: 19/070,215

(22) Filed: Mar. 4, 2025

(30) Foreign Application Priority Data
Mar. 12, 2024 (CN) 202410277900.4

(51) Int. Cl. E03C 1/04

(52) U.S. Cl. CPC E03C 1/0404; E03C 2001/0415

(57) ABSTRACT

A faucet including a bottom support, a spout body coupled to the bottom support, the spout body having an internal opening extending from a top surface to a bottom surface of the spout body, a spout tube extending upward from the spout body. The spout tube can be received at least partially within the spout body. The faucet further includes a rotatably flexible spray head having a first spray head tube coupled to a second spray head tube via a pivot element. The pivot element enables rotation of the second spray head tube relative to the first spray head tube to provide movement of the spray head in multiple directions. The first spray head tube generally remains stationary during rotation of the second spray head tube. The faucet can actuate between a lowered position and one or more raised positions, without external intervention.

### RELATED APPLICATIONS

This application claims priority to Chinese Utility Model patent application Ser. No. 202410277900.4, entitled “Height Adjustable Faucet and Rotatably Flexible Spray Head” and filed on Mar. 12, 2024, the entirety of which is hereby incorporated by reference.

### TECHNICAL FIELD

The present disclosure generally relates to faucets. More specifically, the present disclosure relates to height adjustable faucets and spray heads that are rotatable with flexible positioning.

### BACKGROUND

Conventional faucets typically have a fixed height that is not adjustable to accommodate different users, spaces, or faucet applications. There are several issues with such fixed height faucets. For example, tall faucets can cause fluid splashing due to the considerable distance between the spray head and the sink basin. Tall faucets can also conflict with rear windows or other objects that are at the same height as the faucet. Short faucets may have reduced access because of their small form factors and are generally not suitable for tall individuals who must uncomfortably bend over to operate such faucets. Additionally, conventional faucets typically have a stationary spray head that is not rotatable to reach multiple positions in a sink basin. This limits, among other things, user control in operating the spray head, user comfort because of the restricted mobility of the spray head, and user safety given the uncontrolled fluid spray in a single direction.

Accordingly, height adjustable faucets and rotatably flexible spray heads are desirable to remedy many of the issues associated with conventional faucets and spray heads. The present disclosure addresses this desire through description of various faucets and spray head examples that include a height adjustability feature and/or a mechanism to enable rotation of a spray head in multiple directions.

### SUMMARY

Examples of the present disclosure relate to improved faucet and faucet spray head designs that improve user control, comfort, and safety, among other advantages over conventional designs. In particular, the present disclosure relates to height adjustable faucets and faucet spray heads that are both rotatable and flexible.

In an example, a height adjustable faucet may include a bottom support, such as an escutcheon, a spout body coupled to the bottom support, the spout body having an internal opening extending from a top surface of the spout body to a bottom surface of the spout body. The height adjustable faucet may further include a first spout tube or spout section extending upward from the spout body, the first spout tube configured to be received at least partially within the spout body, a second spout tube or spout section coupled to the first spout tube, and a fluid dispensing unit coupled to the second spout tube, the fluid dispensing unit configured to enable fluid flow out of the height adjustable faucet. The height adjustable faucet may be configured to automatically actuate, via an actuator, between a lowered position and one or more raised positions, without external intervention, or may be manually actuated.

In an example, the bottom support may be configured to abut and be coupled to a countertop surface. In an example, operation of the actuator can engage or disengage a locking mechanism positioned within the spout body, thereby enabling movement between the lowered position and the one or more raised positions. In an example, the height adjustable faucet may further include an activation device configured to activate the actuator to enable movement between the lowered position and the one or more raised positions. In an example, the spout body and the first spout tube may be at least substantially parallel with each other. In an example, the first spout tube and the second spout tube may be at least substantially perpendicular with each other. In an example, the height adjustable faucet may further include a flow control handle coupled at an angle to the spout body.

In an example, the height adjustable faucet may further include a flow control knob coupled to the flow control handle, the flow control knob configured to engage or disengage fluid flow through the height adjustable faucet. In an example, the second spout tube may include a pair of rounded portions separated by a linear portion to give the second spout tube a U-shape. In an example, the height adjustable faucet may further include a sensor configured to sense external movement, the sensor further configured to instruct the actuator to automatically enable movement between the lowered position and the one or more raised positions when external movement is detected. In an example, the lowered position may correspond to the first spout tube being received within the entire internal opening of the spout body. In an example, the one or more raised positions may correspond to the first spout tube being received within a portion of the internal opening of the spout body.

In an example, a rotatably flexible spray head for use with a faucet may include a first spray head tube and a second spray head tube coupled to the first spray head tube via a pivot element. The second spray head tube may have a fluid dispensing unit received therein, wherein the pivot element enables rotation of the second spray head tube relative to the first spray head tube to provide movement of the rotatably flexible spray head in multiple directions. The first spray head tube may remain stationary during rotation of the second spray head tube.

In an example, the rotatably flexible spray head may further include a rotation control mechanism configured to enable rotation of the second spray head tube when the rotation control mechanism is activated. In an example, the rotation control mechanism may be a button positioned on the second spray head tube. In an example, the pivot element may include a spherical pivot piece coupled to an extension piece, the spherical pivot piece being positioned within the first spray head tube, the extension piece being positioned partially within the second spray head tube, such that rotation of the spherical pivot piece enables concurrent rotation of the second spray head tube. In an example, the pivot element can enable unrestricted rotation of the second spray head tube relative to the first spray head tube. In an example, the pivot element can enable 360-degree rotation of the second spray head tube at an approximately 65-degree displacement from a longitudinal axis of the second spray head tube. In an example, the first and second spray head tubes and the pivot element may be configured to transition from a locked position where rotation of the second spray head tube is inhibited, to an unlocked position where rotation of the second spray head tube is enabled.

In an example, the locked position may be activated automatically when fluid flow is turned off, and the unlocked position is activated automatically when fluid flow is turned on. In an example, the pivot element may be configured to enable horizontal movement of the second spray head tube away from the first spray head tube, such that a gap is formed between the first and second spray head tubes when the rotatably flexible spray head is activated. In an example, the pivot element may be configured to enable vertical movement of the second spray head tube away from the first spray head tube, such that a gap is formed between the first and second spray head tubes when the rotatably flexible spray head is activated. In an example, the second spray head tube may be positioned at least substantially perpendicular to at least a portion of the first spray head tube. In an example, the second spray head tube may be positioned at least substantially parallel to at least a portion of the first spray head tube.

In an example, a faucet may include a bottom support, a spout body coupled to the bottom support, the spout body having an internal opening extending from a top surface of the spout body to a bottom surface of the spout body. The faucet may further include a spout tube extending upward from the spout body, the spout tube configured to be received at least partially within the spout body. The faucet may further include a rotatably flexible spray head having a first spray head tube coupled to a second spray head tube via a pivot element, wherein the pivot element enables rotation of the second spray head tube relative to the first spray head tube to provide movement of the rotatably flexible spray head in multiple directions, the first spray head tube remaining stationary during rotation of the second spray head tube. The faucet may be configured to actuate, via an actuator, between a lowered position and one or more raised positions, without external intervention.

In an example, operation of the actuator can engage or disengage a locking mechanism positioned within the spout body, thereby enabling movement between the lowered position and the one or more raised positions. In an example, the faucet may further include an activation device configured to activate the actuator. In an example, the faucet may further include a flow control handle coupled to the spout body, the flow control handle having a flow control knob configured to engage or disengage fluid flow through the faucet. In an example, the faucet may further include a sensor configured to sense external movement, the sensor further configured to instruct the actuator to automatically enable movement between the lowered position and the one or more raised positions when external movement is detected. In an example, the lowered position can correspond to the spout tube being received within the entire internal opening of the spout body. In an example, the one or more raised positions correspond to the spout tube being received within a portion of the internal opening of the spout body. In an example, the faucet may further include a rotation control mechanism configured to enable rotation of the second spray head tube when the rotation control mechanism is activated. In an example, the rotation control mechanism can be a button positioned on the second spray head tube.

In an example, the pivot element may include a spherical pivot piece coupled to an extension piece, the spherical pivot piece being positioned within the first spray head tube, the extension piece being positioned partially within the second spray head tube, such that rotation of the spherical pivot piece enables concurrent rotation of the second spray head tube. In an example, the first and second spray head tubes and the pivot element can be configured to transition from a locked position where rotation of the second spray head tube is inhibited, to an unlocked position where rotation of the second spray tube is enabled. In an example, the locked position can be activated automatically when fluid flow is turned off, and the unlocked position is activated automatically when fluid flow is turned on. In an example, the pivot element can be configured to enable horizontal movement of the second spray head tube away from the first spray head tube, such that a gap is formed between the first and second spray head tubes when the rotatably flexible spray head is activated. In an example, the pivot element can be configured to enable vertical movement of the second spray head tube away from the first spray head tube, such that a gap is formed between the first and second spray head tubes when the spray head is activated.

The above summary is not intended to describe each illustrated example or every implementation of the subject matter hereof. The figures and the detailed description that follow more particularly exemplify various examples.

### BRIEF DESCRIPTION OF THE DRAWINGS

The disclosure may be more completely understood in consideration of the following detailed description of examples of the disclosure in connection with the accompanying drawing, in which:

FIG. 1A is a perspective view of a height adjustable faucet in a lowered position, according to an example of the present disclosure.

FIG. 1B is a perspective view of a height adjustable faucet in a raised position, according to an example of the present disclosure.

FIG. 2A is a perspective view of a first rotatably flexible faucet spray head in a locked position, according to an example of the present disclosure.

FIG. 2B is a perspective view of the first rotatably flexible faucet spray head in an unlocked position, according to an example of the present disclosure.

FIGS. 2C and 2D are perspective views of the first rotatably flexible faucet spray head in separate rotated positions, according to examples of the present disclosure.

FIG. 3A is a perspective view of a second rotatably flexible faucet spray head in a locked position, according to an example of the present disclosure.

FIG. 3B is a perspective view of the second rotatably flexible faucet spray head in an unlocked position, according to an example of the present disclosure.

FIG. 4A is a perspective view of a third rotatably flexible faucet spray head in an unrotated position, according to an example of the present disclosure.

FIG. 4B is a perspective view of the third rotatably flexible faucet spray head in a rotated position, according to an example of the present disclosure.

FIG. 5A is a perspective view of a fourth rotatably flexible faucet spray head in an unrotated position, according to an example of the present disclosure.

FIG. 5B is a perspective view of the fourth rotatably flexible faucet spray head in a rotated position, according to an example of the present disclosure.

FIG. 6 is a cross-section view of a rotatably flexible faucet spray head, according to an example of the present disclosure.

FIG. 7A is a series of detailed part views of the rotatably flexible faucet spray head of FIG. 6, according to an example of the present disclosure.

FIG. 7B is a side view depicting front and rear angular motion of the rotatably flexible faucet spray head of FIG. 6, according to an example of the present disclosure.

FIG. 7C is a series of detailed part views of the rotatably flexible faucet spray head of FIG. 6, according to an example of the present disclosure.

FIG. 7D is a side view depicting left and right angular motion of the rotatably flexible faucet spray head of FIG. 6, according to an example of the present disclosure.

While various examples are amenable to various modifications and alternative forms, specifics thereof have been shown by way of example in the drawings and will be described in detail. It should be understood, however, that the intention is not to limit the claimed inventions to the particular examples described. On the contrary, the intention is to cover all modifications, equivalents, and alternatives falling within the spirit and scope of the subject matter as defined by the claims.

### DETAILED DESCRIPTION OF THE DRAWINGS

The following detailed description should be read with reference to the drawings in which similar elements in different drawings are numbered the same. The drawings, which are not necessarily to scale, depict illustrative examples and are not intended to limit the scope of the disclosure.

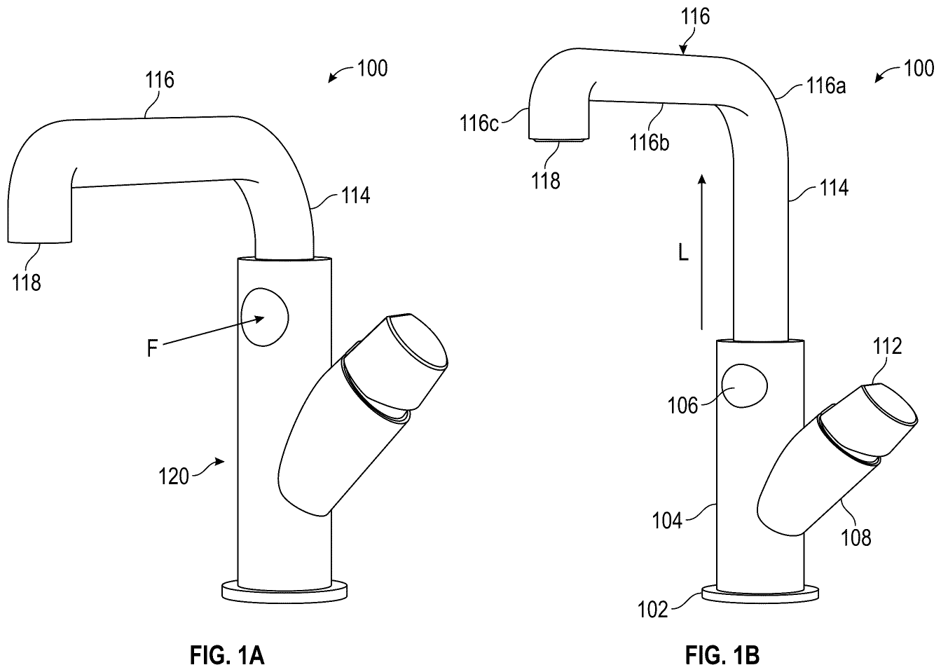

Referring to FIGS. 1A and 1B, a height adjustable faucet 100 may include a bottom support or escutcheon 102 configured to mount to and abut a countertop or sink surface, a spout body 104 couplable to the bottom support 102, an actuator such as a button 106 couplable to the spout body 104, the button 106 configured to activate the height adjustability feature of the faucet 100, a flow control handle 108 extending outward from the spout body 104 at an angle, the flow control handle 108 having a flow control knob 112 couplable to a distal end portion thereof. The height adjustable faucet 100 may further include a first spout tube 114 couplable to and nestable within the spout body 104, a second spout tube 116 couplable to or extending from the first spout tube 114, a fluid dispensing unit 118 such as a spray head or an aerator couplable to the second spout tube 116, and a locking mechanism 120 generally positioned within the spout body 104.

In examples, the components of height adjustable faucet 100 may be separate, discrete units, or may be integrally connected to form one or more assemblies (e.g., first and second spout tubes 114, 116 may comprise a single, integral spout tube 114/116). In one specific example, first spout tube 114 may extend in a generally vertical direction from a countertop, while second spout tube 116 may extend at an angle from first spout tube, such that spout tube 116 extends in a generally horizontal direction from the countertop. Height adjustable faucet 100 may be manufactured from a variety of materials known to one of ordinary skill in the art, including metals and polymers.

FIGS. 1A and 1B depict the height adjustable faucet 100 in a lowered position and in a raised position, respectively. The lowered position corresponds to the first spout tube 114 being received or nested at least partially within the spout body 104, whereas the raised position corresponds to the first spout tube 114 extending out of the spout body 104 at a length L. Movement between the lowered and raised positions is affected using button 106 which engages or disengages locking mechanism 120, thereby enabling movement of first spout tube 114 outward from or inward to spout body 104. Locking mechanism 120 can comprise a knob (not shown) coupled to button 106 and configured to engage a plurality of holes (not shown) in a portion of first spout tube 114 nested within spout body 104. Alternatively, locking mechanism 120 can comprise a ratchet mechanism with steps formed on an outer surface of body 104, while button 106 is coupled to a tooth configured to engage one of the steps when button 106 is depressed.

The raised position may correspond to any number of lengths L between second spout tube 116 and spout body 104 (i.e., the length L between second spout tube 116 and spout body 104 increases as height adjustable faucet 100 is moved from the lowered position to the raised position). For example, length L may range from approximately three inches to 10 inches, though other lengths L are contemplated by the present disclosure for different faucet applications. Accordingly, height adjustable faucet 100 may be configured to actuate between one or more raised positions each having a different length L between second spout tube 116 and spout body 104.

In this example, bottom support 102 generally has a thin cylindrical geometry with a bottom surface configured to abut a countertop or sink surface, and a top surface configured to couple to a bottom surface of the spout body 104. Other geometries such as rectangular or triangular escutcheons are contemplated for bottom support 102 by the present disclosure. Bottom support 102 may also include an internal opening extending from the bottom surface to the top surface to enable the flow of fluid through the bottom support 102 and into the spout body 104 and first spout tube 114. In examples, bottom support 102 has a diameter of approximately one to three inches, though other diameters less than or greater than this range are contemplated by the present disclosure for different faucet applications.

Spout body 104 generally has a cylindrical geometry with a bottom surface coupled to the top surface of the bottom support 102, and a top surface configured to receive the first spout tube 114. Spout body 104 may include an internal opening extending from the bottom surface to the top surface such that first spout tube 114 can be received within the internal opening when height adjustable faucet 100 is in the lowered position. In examples, spout body 104 may have a diameter of approximately one to three inches, though other diameters less than or greater than this range are contemplated by the present disclosure for different faucet applications. In examples, spout body 104 may have a length of approximately five to 15 inches, though other lengths less than or greater than this range are contemplated by the present disclosure for different faucet applications.

Button 106 is generally positioned on an outer surface of spout body 104, though in other examples button 106 may be positioned on other components of height adjustable faucet 100 such as flow control handle 108, or may be separate from height adjustable faucet 100 but still operationally couplable to enable movement of height adjustable faucet 100 between one or more raised positions and the lowered position. Button 106 generally has a circular geometry, though other geometries such as square, rectangular, and triangular are contemplated by the present disclosure. Button 106 may be coupled to a locking mechanism 120 positioned within spout body 104. In examples, button 106 may be replaced with any suitable knob, switch, lever, key, controller, or any other activation device for a height actuator, to achieve the same functionality as button 106. Button 106 may include circuity and other electrical components to effect movement of the height adjustable faucet between the lowered position and the one or more raised positions. In an alternative example, a sensor 122 can be formed within spout body 104, the sensor 122 configured to sense a movement by a user, such as waving up or down, which sends a signal to the actuator to activate the up or down movement of first spout tube 114 relative to spout body 104. The sensor 122 may be positioned at or near the location of button 106 (or other activation device for a height actuator) such that movement or touch by a user near button 106 will activate height adjustment between the one or more raised positions and the lowered position.

When button 106 is interacted with, for example using a push force F, a pull force, a rotation force, hand motion, voice recognition, or any other suitable action, the locking mechanism 120 can become disengaged which enables movement of first spout tube 114 out of spout body 104 from the lowered position to the one or more raised positions. This increases the length L between the top surface of spout body 104 and the second spout tube 116. When button 106 is no longer interacted with (e.g., the user no longer applies a force or other action to the button 106), the locking mechanism 120 can become engaged causing the first spout tube 114 to be rigidly held in place at its current position, with the current length L between spout body 104 and second spout tube 116 being fixed. Further interaction with button 106 disengages the locking mechanism 120 allowing for movement of first spout tube 114 in the manner described.

In an example, when the height adjustable faucet 100 is in the raised position and a user interacts with button 106, the first spout tube 114 can automatically (i.e., without user assistance or intervention) retract into the spout tube 104, thereby placing the height adjustable faucet 100 in the lowered position. The first spout tube 114 can likewise automatically extend out of the spout tube 104 thereby placing the height adjustable faucet 100 in the raised position. Alternatively, in an example, when the height adjustable faucet 100 is in the raised position, a user may apply a downward force onto the second spout tube 116 to move the height adjustable faucet 100 to the lowered position.

Flow control handle 108 generally has a cylindrical geometry with a bottom surface coupled to the outer surface of spout body 104, and a top surface coupled to the flow control knob 112. Flow control handle 108 generally extends outward at an angle with respect to a longitudinal axis of spout body 104, for example at an angle ranging from approximately 15 degrees to 75 degrees, or at an angle of approximately 45 degrees. Flow control knob 112 generally has a cylindrical geometry with a bottom surface coupled to the top surface of the flow control handle 108, and a top surface configured to be interacted with by a force, such as a user applying a push force to the top surface of the flow control knob 112.

In combination, flow control handle and knob 108, 112 are configured to engage or disengage the flow of fluid from an external fluid source through height adjustable faucet 100. When a force or other action is applied to flow control knob 108, the force or other action is transferred through flow control handle 112 and into spout body 104 which thereafter enables fluid flow into height adjustable faucet 100. Upon releasing the force against flow control knob 112, the flow of fluid into height adjustable faucet 100 is released until a subsequent force is applied. Alternatively, releasing the force against flow control knob 112 has no effect on the flow of fluid. In such an example, to disengage fluid flow through height adjustable faucet 100, a second force applied against flow control knob 112 may be required. The second force disengages the fluid flow until a subsequent force is applied against flow control knob 112, which can cause the resumption of fluid flow.

First spout tube 114 generally has a cylindrical geometry and is configured to be partially received within the internal opening of spout body 104 in both the one or more raised positions and the lowered position (first spout tube 114 is received further within the internal opening in the lowered position). In an example, the lowered position may correspond to the first spout tube 114 being received within the entire internal opening of the spout body 104. The one or more raised positions may correspond to the first spout tube 114 being received within a portion of the internal opening of the spout body 104. The “portion of the internal opening” in which the first spout tube 114 is received will vary depending on the length L of the corresponding raised position.

First spout tube 114 may also include an internal opening extending through its length to enable the flow of fluid through bottom support 102 and spout body 104 and into first spout tube 114. First spout tube 114 is typically coupled on one end to second spout tube 116 as illustrated in FIGS. 1A and 1B. In examples, first spout tube 114 may have a diameter of approximately one to three inches, though other diameters less than or greater than this range are contemplated by the present disclosure for different faucet applications. In examples, first spout tube 114 may have a length of approximately five to 15 inches, though other lengths less than or greater than this range are contemplated by the present disclosure for different faucet applications.

Second spout tube 116 generally has a cylindrical geometry comprising a first rounded portion 116a, a linear portion 116b, and a second rounded portion 116c. In an example, portions 116a,b,c couple together to form a U-shaped geometry. First, second, and linear portions 116a-c are generally integrally connected but may also be removably couplable in other examples. First rounded portion 116a is generally integrally coupled to an end of first spout tube 114 and to an end of linear portion 116b (i.e., coupled on separate ends of first rounded portion 116a). Linear portion 116b is generally integrally coupled to an end of second rounded portion 116c. Because first and second spout tubes 114, 116 are couplable together, moving height adjustable faucet 100 from the lowered position to the raised position raises the height of both first and second spout tubes 114, 116 relative to a countertop or sink surface.

Second spout tube 116 as a whole may include an internal opening extending through its length to enable the flow of fluid from first spout tube 114 into second spout tube 116. The internal opening of second spout tube 116 may have a diameter sized identical to the internal opening of first spout tube 114, or the internal opening of second spout tube 116 may have a smaller or larger diameter to accommodate different faucet applications. In examples, second spout tube 116 may have a combined length of approximately five to 15 inches, though other lengths less than or greater than this range are contemplated by the present disclosure for different faucet applications. Fluid dispensing unit 118 may be received within second spout tube 116, specifically within second rounded portion 116c, and can be configured to enable the flow of fluid out of height adjustable faucet 100 and into a final location such as a sink basin. Movement between the raised and lowered positions likewise changes the height of fluid dispensing unit 118 relative to the countertop or sink surface.

In operation, a height adjustable faucet 100 may be fixedly secured to a countertop or sink surface in any suitable manner, for example using a one-hole installation. Fluid flow from an external source may be engaged or disengaged using a combination of the flow control handle 108 and the flow control knob 112. The height adjustable faucet 100 may be moved from a lowered position to a raised position, or vice versa, upon interaction with button 106 located on, for example, spout body 104. Accordingly, the position of height adjustable faucet 100 may be automatically adjusted to accommodate a wide variety of users, spaces, and faucet applications (e.g., washing pots and/or pans having a large height where it would otherwise be difficult in a regular faucet, moving the faucet into a lowered position to gain access to a window above the faucet, reducing splashing from use of a tall faucet, etc.).

It should be understood that height adjustable faucet 100 may include a variety of internal components to enable the transfer of fluid from an external source through the faucet 100. Example references to such internal components may be found in commonly owned U.S. Pat. Nos. 7,909,269 and 11,231,116, the disclosures of which are both incorporated by reference in their entireties herein. One of ordinary skill in the art has knowledge of the required internal components to enable operation of height adjustable faucet 100 in the manner described herein. Accordingly, such description is not expressly included in the present disclosure but is implicitly included given the disclosures of the named U.S. Patents and the skill of one in the art.

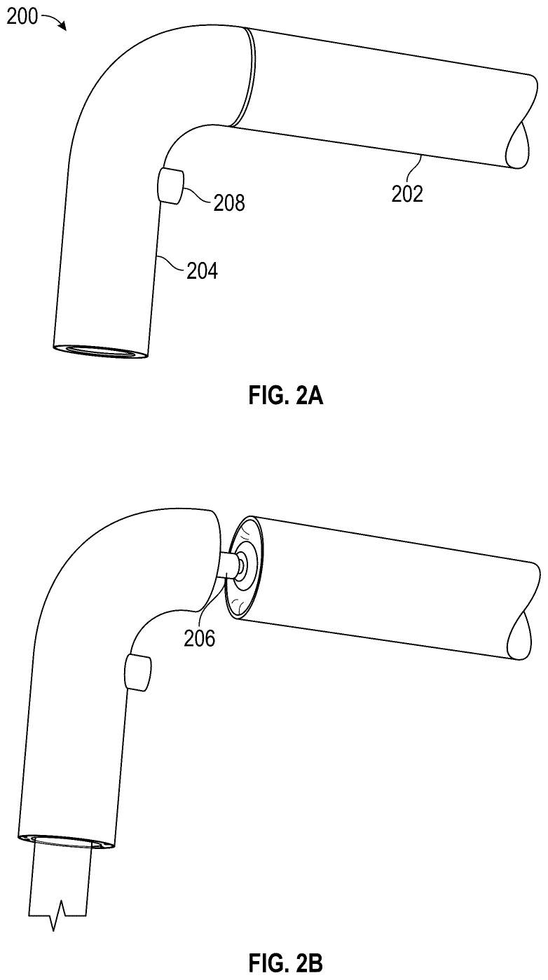

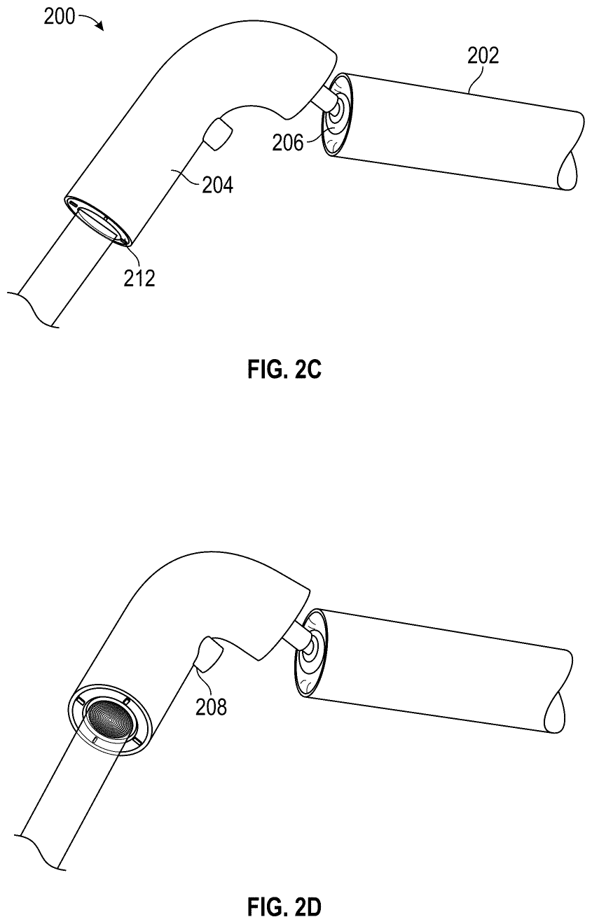

Referring now to FIGS. 2A-2D, a rotatably flexible spray head 200 may include a first tube 202 (i.e., first spray head tube), a second tube 204 (i.e., second spray head tube), a pivot element 206 connecting the first tube 202 to the second tube 204, a rotation control mechanism 208 (e.g., a button, switch, knob, etc.) to enable movement of the rotatably flexible spray head 200 from an unlocked position to a locked position, or vice versa, and a fluid dispensing unit 212 (e.g., a spray head) positioned within the second tube 204. In examples, rotatably flexible spray head 200 may comprise several separate components as described here, or may comprise one or more integrally connected assemblies of components (e.g., first and second tubes 202, 204 integrally connected to form a single tube 202/204). In examples, rotation control mechanism 208 may comprise any suitable knob, switch, lever, key, controller, or any other movement control mechanism. Rotatably flexible spray head 200 may be manufactured from a variety of materials known to one of ordinary skill, including metals and polymers. The material of spray head 200 will generally match the faucet material.

First tube 202 generally has a cylindrical geometry with an internal opening extending through a length to enable the flow of fluid through the first tube 202. In examples, first tube 202 may have a diameter of approximately one to three inches, though other diameters less than or greater than this range are contemplated by the present disclosure for different faucet applications. In examples, first tube 202 may have a length of approximately three to 10 inches, though other lengths less than or greater than this range are contemplated by the present disclosure for different spray head applications. First tube 202 may include a pivot element 206 positioned partially within the internal opening, the pivot element 206 having a spherical pivot piece connected to an extension piece, the extension piece being positioned partially within the second tube 204. As such, pivot element 206 can connect first and second tubes 202, 204 together using a combination of the spherical pivot piece and the extension piece. Additionally, pivot element 206 can enable up to a 360-degree rotation of the second tube 204 at an approximately 65-degree displacement from a longitudinal axis of the second tube 204 (i.e., up, down, front, back, left, and right movement).

Second tube 204 generally has a cylindrical geometry with a rounded portion and a linear portion. Second tube 204 generally has the same diameter as first tube 202, and generally has a similar length in the range of three to 10 inches. An outer surface of second tube 204 may a rotation control mechanism 208 configured to lock or unlock the rotational movement of second tube 204 relative to first tube 202. In general, spray head 212 can be positioned within second tube 204 and can be configured to enable the flow of fluid out of an opening in rotatably flexible spray head 200. In operation, rotatably flexible spray head 200 can be installed into a faucet such as height adjustable faucet 100. Upon installation, rotatably flexible spray head 200 can be configured to maintain a locked position (i.e., retracted position) when fluid flow is turned off. This position is illustrated in FIG. 2A. When fluid flow is turned on, rotatably flexible spray head 200 may automatically transition to an unlocked position (i.e., unrestricted position, able to be rotated) to enable up to a 360-degree rotation of second tube 204 relative to first tube 202. The described rotational movement is illustrated in FIGS. 2B-2D.

In one example, second tube 204 is configured to rotate about 75 degrees in each direction in a horizontal plane, for a total of 150 degrees. Additionally, movement between the locked and unlocked positions can occur using activation of rotation control mechanism 208 by a user. For example, activating rotation control mechanism 208 (e.g., by applying a force) may cause the second tube 204 to transition from the locked position to the unlocked position, while deactivating rotation control mechanism 208 (e.g., by releasing the force) can cause the second tube 204 to return to the locked position. Instead of automatically returning to the locked position upon force release, a user may instead apply a second, subsequent force to rotation control mechanism 208 to return second tube 204 to the locked position. Accordingly, rotatably flexible spray head 200 can, for example, reach every position inside a sink basin or another cleaning area in a controlled, comfortable, and safe manner. Moreover, the integration of first and second tubes 202, 204 creates a sleek product design that is aesthetically appealing.

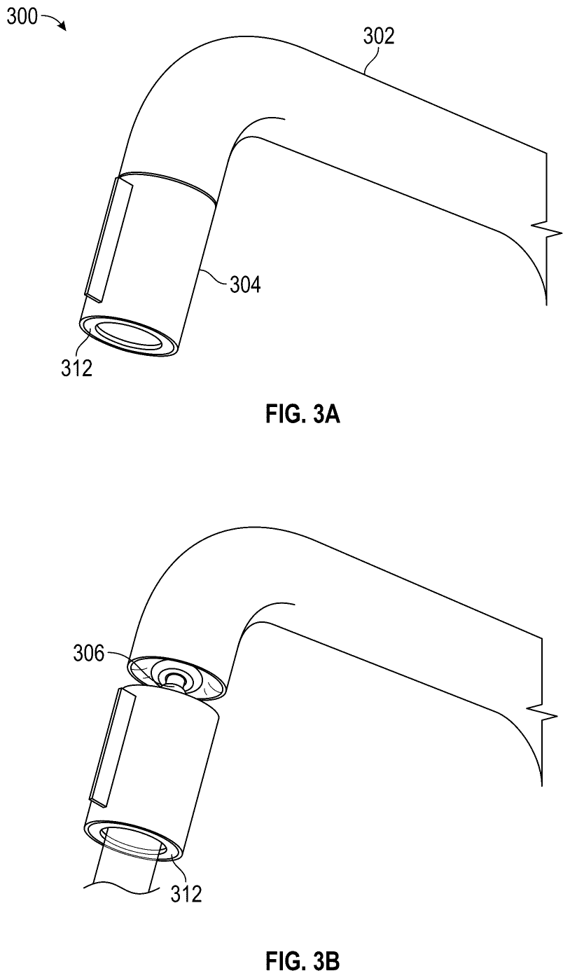

Referring now to FIGS. 3A and 3B, a rotatably flexible spray head 300 may include a first tube 302, a second tube 304, a pivot element 306 connecting the first tube 302 to the second tube 304, and a fluid dispensing unit 312 positioned within the second tube 204. Pivot element 306 is additionally configured to enable vertical movement of second tube 304 away from first tube 302 when fluid flow is turned on (or optionally using a rotational control mechanism such as a button, for example, located on the rotatably flexible spray head 300 or located on a separate faucet component). Rotatably flexible spray head 300 has many similarities to rotatably flexible spray head 200, and for simplicity the description of common components is not repeated in the following. Like reference numerals and features names may designate like feature names throughout that are corresponding or analogous. In an example, second tube 304 may be positioned approximately or at least substantially parallel to at least a portion of first tube 302.

Rotatably flexible spray head 300 can be configured to move between a locked position when fluid flow is turned off (FIG. 3A), and an unlocked position when fluid flow is turned on (FIG. 3B). The locked position generally corresponds to the first and second tubes 302, 304 being coupled to each other via pivot element 306. The unlocked position generally corresponds to the second tube 304 being vertically separated from the first tube 302 by a given distance which may change depending on the particular faucet application and/or user preferences. Once in the unlocked position, second tube 304 can be further configured to rotate 360 degrees at a displacement of approximately 30 degrees from a longitudinal axis of second tube 304 using pivot element 306. Accordingly, rotatably flexible spray head 300 can advantageously achieve significant rotational mobility which enables reaching multiple different positions in a sink basin or another cleaning area.

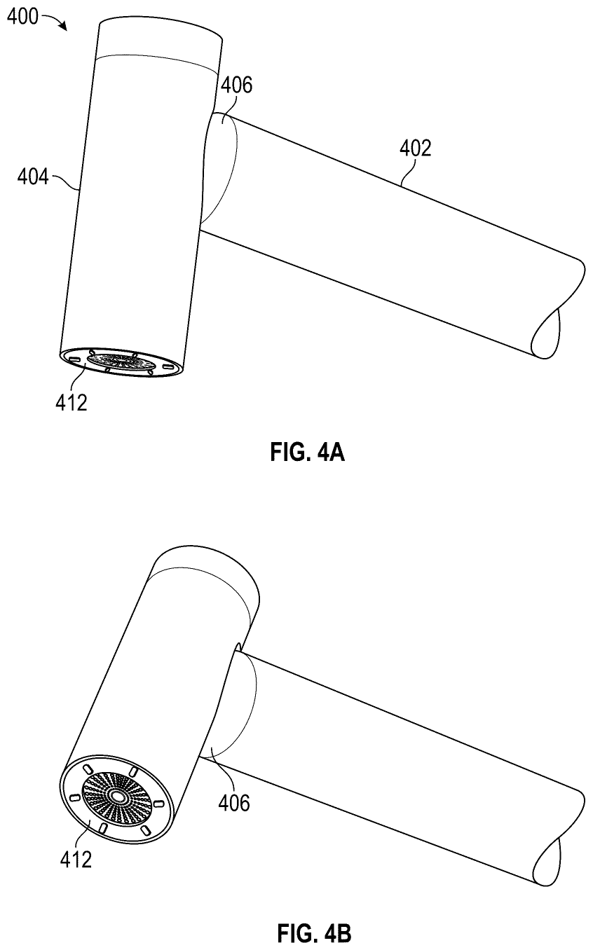

Referring now to FIGS. 4A and 4B, a rotatably flexible spray head 400 may include a first tube 402, a second tube 404, a pivot element 406 connecting the first tube 402 to the second tube 404, and a fluid dispensing unit 412 positioned within the second tube 404. Pivot element 406 is additionally configured to enable horizontal movement of second tube 404 away from first tube 402 when fluid flow is turned on (or optionally using a rotation control mechanism such as a button, for example, located on the rotatably flexible spray head 400 or located on a separate faucet component). Rotatably flexible spray head 400 has many similarities to rotatably flexible spray heads 200 and 300, and for simplicity the description of common components is not repeated in the following. Like reference numerals and features names may designate like feature names throughout that are corresponding or analogous.

Rotatably flexible spray head 400 can be configured to move between a locked position when fluid flow is turned off (FIG. 4A), and an unlocked position when fluid flow is turned on (FIG. 4B). The locked position generally corresponds to the first and second tubes 402, 404 being coupled to each other via pivot element 406, such that first tube 402 is approximately or at least substantially perpendicular to second tube 404 in this position. The unlocked position generally corresponds to the second tube 404 being configured to rotate in any angle with respect to the first tube 402. Like previous spray heads, this advantageously enables rotatably flexible spray head 400 to reach any location in a sink basin or another cleaning area in a controlled, comfortable, and safe manner.

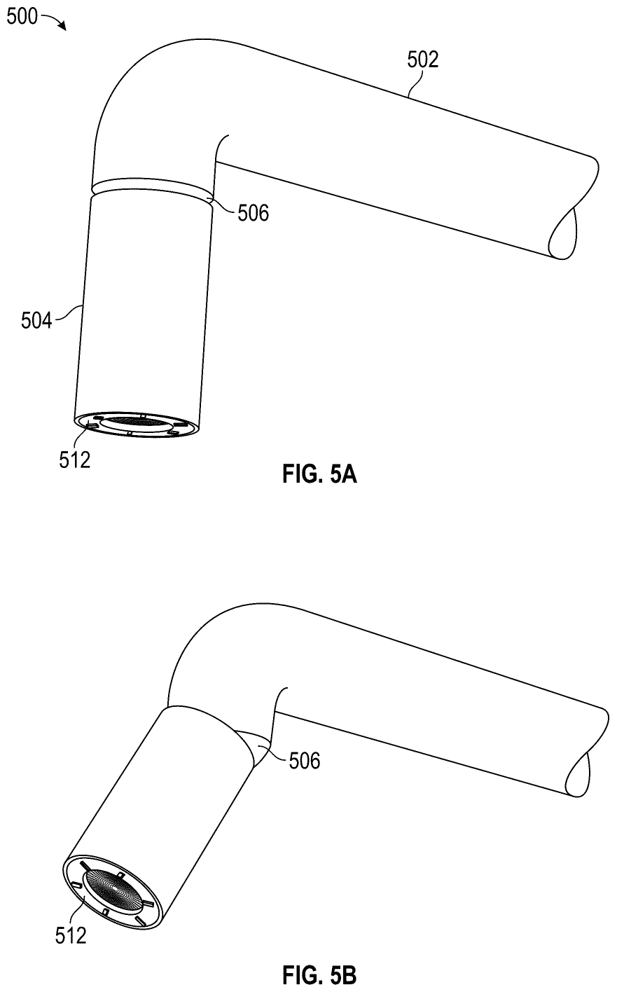

Referring now to FIGS. 5A and 5B, a rotatably flexible spray head 500 may include a first tube 502, a second tube 504, a pivot element 506 connecting the first tube 502 to the second tube 504, and a fluid dispensing unit 512 positioned within the second tube 504. Pivot element 506 can be additionally configured to enable vertical movement of second tube 504 away from first tube 502 when fluid flow is turned on (or optionally using a rotation control mechanism such as a button, for example, located on the rotatably flexible spray head 500 or located on a separate faucet component). Rotatably flexible spray head 500 has many similarities to rotatably flexible spray heads 200, 300 and 400, and for simplicity the description of common components is not repeated in the following. Like reference numerals and features names may designate like feature names throughout that are corresponding or analogous.

Rotatably flexible spray head 500 can be configured to move between a locked position when fluid flow is turned off (FIG. 5A), and an unlocked position when fluid flow is turned on (FIG. 5B). The locked position generally corresponds to the first and second tubes 502, 504 being coupled to each other via pivot element 506. The unlocked position generally corresponds to the second tube 504 being configured to turn approximately 30 degrees from a longitudinal axis of second tube 504 (hereinafter, “shifted axis”), and then subsequently configured to rotate 180 degrees around the shifted axis. This enables rotatably flexible spray head 500 to reach any location in a sink basin or another cleaning area within the 180-degree axis of rotation, thereby providing better rotational mobility than conventional spray heads.

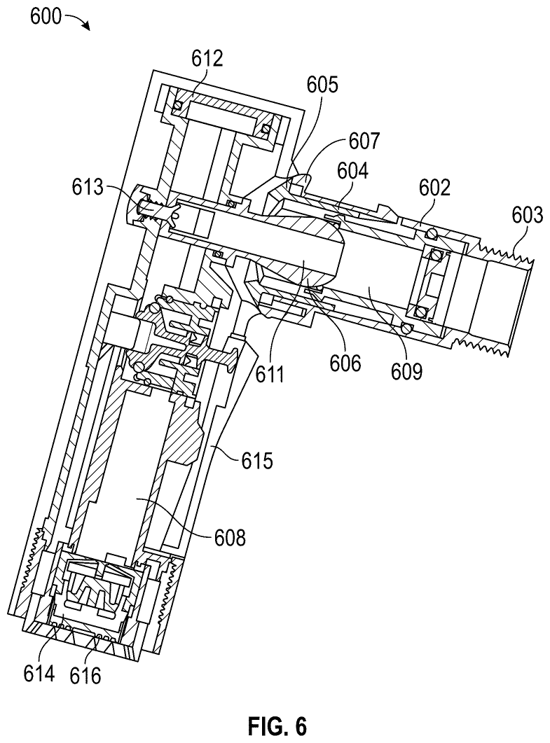

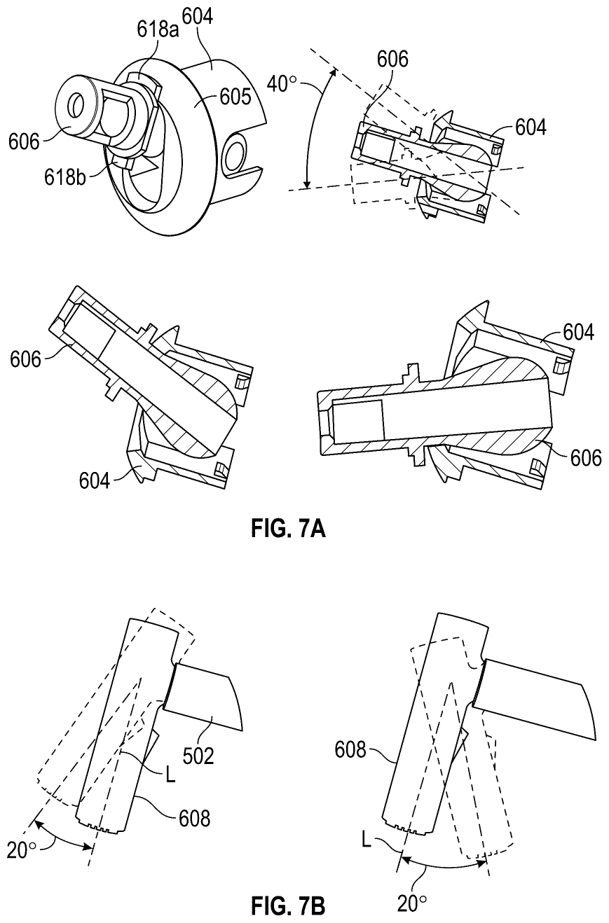

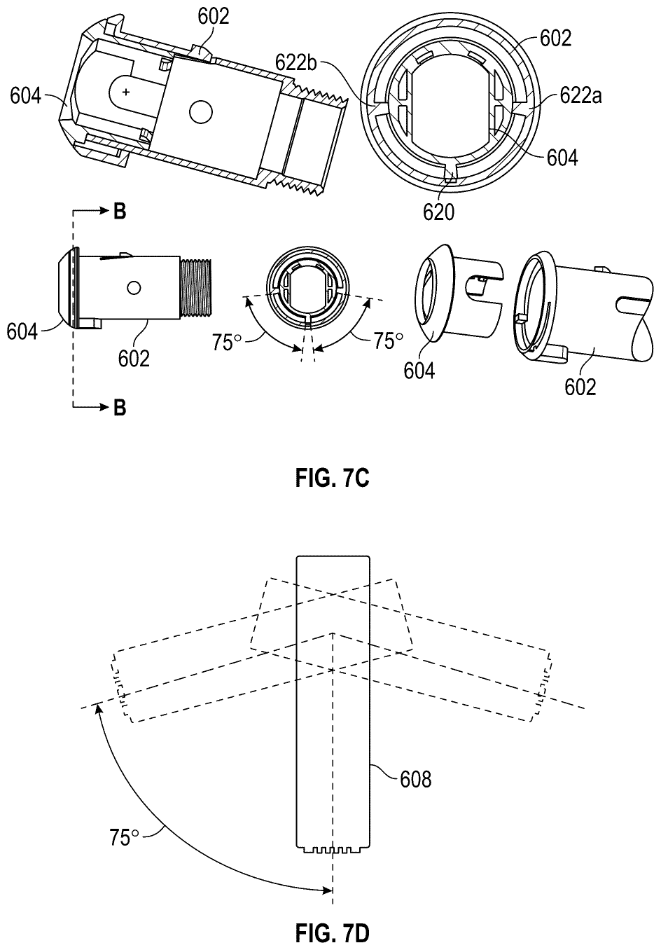

Referring now generally to FIGS. 6-7D, an example of a rotatably flexible spray head assembly 600 may include a coupling 602, a cap 604 coupled to the first coupling 602, a pivot element 606 partially arranged within the first coupling 602 and the cap 604, a fluid dispensing unit 608 extending from a distal end portion 612 to a proximal end portion 614, and a fluid outlet 614 such as an aerator coupled to the proximal end portion 614 of the fluid dispensing unit 608. The example of the rotatably flexible spray head 600 has many similarities to previously described rotatably flexible spray heads (e.g., rotatably flexible spray head 400), and for simplicity the description of common components is not repeated in the following. Like reference numerals and features names may designate like feature names throughout that are corresponding or analogous.

Referring specifically to FIG. 6, a cross-section view of the rotatably flexible spray head assembly 600 illustrates the interconnectivity between the various components included therein. The coupling 602 is configured to be coupled within a faucet component such as tube 502, as described above. For example, coupling 602 can have threading 603 on an external surface of a first end of the coupling 602 to engage with corresponding groves (not shown) formed in an inner surface of a faucet component to secure the coupling 602 within tube 502. Cap 604 is secured on a top or second end of the coupling 602 and is nested within the coupling 602 until an annular flange 605 of the cap 604 abuts an annular ledge 607 formed on the second end of the coupling 602. A first end of the pivot element 606 nests within the top end of the cap 604 such that a fluid conduit 609 within the coupling 602 is in fluid communication with a fluid conduit 611 of the cap 604. A second end of the pivot element 606 is secured to the fluid dispensing unit 608 via a fastener 613 fixed within an interior of the fluid dispensing unit 608. The fluid dispensing unit 608 can include toggle 615 for toggling between different spray configurations of the fluid dispensing unit 608, such as aerated, stream, spray, or any of a variety thereof.

Referring now specifically to FIGS. 7A and 7B, the interaction between cap 604 and pivot element 606 can enable the pivot element 606 to rotate upward and downward (e.g. pitch) along a 40-degree path of movement (i.e., 20 degrees upward and 20 degrees downward from a longitudinal axis L of the coupling 602). However, the path of movement can be more or less than 40-degrees so long as the fluid conduits 609 and 611 stay fluidly coupled. Tabs 618a, 618b formed midway along a length of the pivot element 606 are spaced 180 degrees apart from one another. As the pivot element 606 moves in one direction, e.g., upward away from the longitudinal axis L, its movement is limited by tab 618a abutting annular flange 605 of the cap 604. Similarly, as the pivot element 606 moves in one direction, e.g., downward away from the longitudinal axis L, its movement is limited by tab 618b abutting annular flange 605 of the cap 604. Referring to FIG. 7B, the pivot element 606 can control the frontward and rearward angles, i.e., pitch, of the fluid dispensing unit 608, resulting in the 20-degree upward and downward rotational movement shown in FIG. 7B in one example.

Referring now specifically to FIGS. 7C and 7D, the interaction between first spray tube 602 and cap 604 can control the leftward and rightward angles, i.e., yaw, of the fluid dispensing unit 608 relative to the faucet portion 502, resulting in the 75-degree leftward and rightward rotational movement shown in FIG. 7D. However, the path of movement can be more or less than 75-degrees so long as the fluid conduits 609 and 611 stay fluidly coupled. In this example, the cap 604 is rotatable within and with respect to the coupling 602. The coupling 602 includes tabs 622a and 622b projecting radially inwardly from an inner surface of the coupling 602 on opposite sides of the coupling 602. A protrusion 620 is formed on an outer surface of the cap 604. As the fluid dispensing unit 608 is rotated about the longitudinal axis L of the coupling 602, the pivot element 606 and cap 604 also rotate about the longitudinal axis L because the pivot element 606 is fixed to the fluid dispensing unit 608 by the fastener 613 and the pivot element 606 is rotationally fixed to the cap 604. The cap 604 is configured to rotate in a first direction (e.g., counterclockwise) until the protrusion 620 abuts tab 622a of the coupling 602, and the cap 604 is configured to rotate in a second direction (e.g., clockwise) until the protrusion 620 abuts tab 622b of the coupling 602. In one example, based on the widths of tabs 622a, 622b, and the protrusion 620, fluid dispensing unit 608 can rotate up to about 75 degrees in each direction for a total of about 150 degrees.

The disclosure may be embodied in other specific forms without departing from the essential attributes. Therefore, the illustrated examples should be considered illustrative and not restrictive in all respects. Any claims provided herein are to ensure adequacy of the present application for establishing foreign priority and for no other purpose.

Various examples of systems, devices, and methods have been described herein. These examples are given only be way of example and are not intended to limit the scope of the claimed disclosures. It should be appreciated, moreover, that the various features of the examples that have been described may be combined in various ways to produce numerous additional examples. Moreover, while various material, dimensions, shapes, configurations, locations, etc. have been described for use with disclosed examples, others besides those disclosed may be utilized without exceeding the scope of the claimed disclosures.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples can comprise a combination of different individual features selected from different individual examples, as understood be persons of ordinary skill in the art. Moreover, elements described with respect to one example can be implemented in other examples even when not described in such examples unless otherwise noted.

Any incorporation of reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

1. A height adjustable faucet, comprising:
a bottom support;
a spout body coupled to the bottom support, the spout body having an internal opening extending from a top surface of the spout body to a bottom surface of the spout body;
a first spout tube extending upward from the spout body, the first spout tube configured to be received at least partially within the spout body;
a second spout tube coupled to the first spout tube; and
a fluid dispensing unit coupled to the second spout tube, the fluid dispensing unit configured to enable fluid flow out of the height adjustable faucet,
wherein the height adjustable faucet is configured to automatically actuate, via an actuator, between a lowered position and one or more raised positions.

2. (canceled)

3. The height adjustable faucet of claim 1, wherein operation of the actuator engages or disengages a locking mechanism positioned within the spout body, thereby enabling movement between the lowered position and the one or more raised positions.

4. (canceled)

5. The height adjustable faucet of claim 1, wherein the spout body and the first spout tube are at least substantially parallel with each other.

6. The height adjustable faucet of claim 1, wherein the first spout tube and the second spout tube are at least substantially perpendicular with each other.

7. The height adjustable faucet of claim 1, further comprising a flow control handle coupled at an angle to the spout body.

8. (canceled)

9. (canceled)

10. The height adjustable faucet of claim 1, further comprising a sensor configured to sense external movement, the sensor further configured to instruct the actuator to automatically enable movement between the lowered position and the one or more raised positions when external movement is detected.

11. The height adjustable faucet of claim 1, wherein the lowered position corresponds to the first spout tube being received within the entire internal opening of the spout body.

12. The height adjustable faucet of claim 1, wherein the one or more raised positions correspond to the first spout tube being received within a portion of the internal opening of the spout body.

13. A rotatably flexible spray head for use with a faucet, comprising:
a first spray head tube; and
a second spray head tube coupled to the first spray head tube via a pivot element, the second spray head tube having a fluid dispensing unit received therein, wherein the pivot element enables rotation of the second spray head tube relative to the first spray head tube to provide movement of the rotatably flexible spray head in multiple directions, the first spray head tube remaining stationary during rotation of the second spray head tube.

14. (canceled)

15. (canceled)

16. The rotatably flexible spray head of claim 13, wherein the pivot element includes a spherical pivot piece coupled to an extension piece, the spherical pivot piece being positioned within the first spray head tube, the extension piece being positioned partially within the second spray head tube, such that rotation of the spherical pivot piece enables concurrent rotation of the second spray head tube.

17. The rotatably flexible spray head of claim 13, wherein the pivot element enables unrestricted rotation of the second spray head tube relative to the first spray head tube.

18. (canceled)

19. The rotatably flexible spray head of claim 13, wherein the first and second spray head tubes and the pivot element are configured to transition from a locked position where rotation of the second spray head tube is inhibited, to an unlocked position where rotation of the second spray head tube is enabled.

20. (canceled)

21. The rotatably flexible spray head of claim 13, wherein the pivot element is configured to enable horizontal movement of the second spray head tube away from the first spray head tube, such that a gap is formed between the first and second spray head tubes when the rotatably flexible spray head is activated.

22. The rotatably flexible spray head of claim 13, wherein the pivot element is configured to enable vertical movement of the second spray head tube away from the first spray head tube, such that a gap is formed between the first and second spray head tubes when the rotatably flexible spray head is activated.

23. (canceled)

24. (canceled)

25. A faucet, comprising:
a bottom support;
a spout body coupled to the bottom support, the spout body having an internal opening extending from a top surface of the spout body to a bottom surface of the spout body;
a spout tube extending upward from the spout body, the spout tube configured to be received at least partially within the spout body; and
a rotatably flexible spray head having a first spray head tube coupled to a second spray head tube via a pivot element, wherein the pivot element enables rotation of the second spray head tube relative to the first spray head tube to provide movement of the rotatably flexible spray head in multiple directions, the first spray head tube remaining stationary during rotation of the second spray head tube,
wherein the faucet is configured to actuate, via an actuator, between a lowered position and one or more raised positions, without external intervention.

26. The faucet of claim 25, wherein operation of the actuator engages or disengages a locking mechanism positioned within the spout body, thereby enabling movement between the lowered position and the one or more raised positions.

27. (canceled)

28. (canceled)

29. The faucet of claim 25, further comprising a sensor configured to sense external movement, the sensor further configured to instruct the actuator to automatically enable movement between the lowered position and the one or more raised positions when external movement is detected.

30. (canceled)

31. (canceled)

32. The faucet of claim 25, further comprising a rotation control mechanism configured to enable rotation of the second spray head tube when the rotation control mechanism is activated.

33. (canceled)

34. The faucet of claim 25, wherein the pivot element includes a spherical pivot piece coupled to an extension piece, the spherical pivot piece being positioned within the first spray head tube, the extension piece being positioned partially within the second spray head tube, such that rotation of the spherical pivot piece enables concurrent rotation of the second spray head tube.

35. The faucet of claim 25, wherein the first and second spray head tubes and the pivot element are configured to transition from a locked position where rotation of the second spray head tube is inhibited, to an unlocked position where rotation of the second spray tube is enabled.

36-38. (canceled)
